(19) United States
(12) Patent Application Publication
(10) Pub. No.: US 2012/0160534 A1
(43) Pub. Date: Jun. 28, 2012

(54) Additional Handgrip, Hand-held Power Tool, System

(75) Inventor: Constantin Von Saucken, Muenchen (DE)

(73) Assignee: Hilti Aktiengesellschaft, Schaan (LI)

(21) Appl. No.: 13/333,581

(22) Filed: Dec. 21, 2011

(30) Foreign Application Priority Data
Dec. 22, 2010 (DE) 10 2010 063 885.4

(51) Int. Cl. B25F 5/02; B25G 1/00

(52) U.S. Cl. 173/170; 16/426

(57) ABSTRACT

An additional handgrip is disclosed. The additional handgrip is connectable to a hand-held power tool. The additional handgrip includes a fastening element designed for attachment to the connection area, a grip designed for handling, and a locking coupling connecting the grip and the fastening element. The locking coupling is adjustable by the grip between a position attaching the fastening element and a detachment position, and has a first coupling part that can be actuated via the grip and a second coupling part designed to adjust the fastening element. The first and second coupling parts form a bayonet lock, where the bayonet lock is formed by an engagement element engaging in a guide such that when moving the engagement element between a first point of the guide and a second point of the guide, the fastening element is adjusted between the attachment and detachment position.

This application claims the priority of German Patent Document No. 10 2010 063 885.4, filed Dec. 22, 2010, the disclosure of which is expressly incorporated by reference herein.

### BACKGROUND AND SUMMARY OF THE INVENTION

The invention relates to an additional handgrip. The invention also relates to a hand-held power tool. The invention relates further to a system of a hand-held power tool and additional handgrip, such as arranged in a tool box or the like, for example.

Almost all hand-operated power tools, for example in the form of a power tool or the like, have at least one connection possibility for an additional handgrip of the type cited at the outset. An additional handgrip is supposed to facilitate the guidance of a hand-held power tool and/or, if applicable, contain any torques generated. An additional handgrip is thus a component that is relevant for regulatory approval.

An additional handgrip is disclosed, for example, in German Patent Document No. DE 37 31 059 or European Patent Document No. EP 2 191 941 A2 in accordance with the type cited at the outset. In this case, fastening of the additional handgrip is accomplished by means of a screw connection between the fastening element and the grip. The fastening element is designed in the cited applications as a tension band or tension clamp and grips around the tool neck of the hand-held power tool in a frictional manner when the screw connection is tightened.

The otherwise proven advantageous design of the additional handgrip is nevertheless worthy of improvement. It turns out that actuating the screw connection via the grip can be comparatively time-consuming since the grip must be rotated comparatively frequently, because, on the one hand, a comparatively large tension path must be covered for detaching or tensioning actuation, and, on the other hand, however, an increased power-enhancing effect of the screw connection is actually required only in the case of relatively few final revolutions. The result of this is that most of the revolutions of a grip for actuating the screw connection take place virtually without counterforce and the operator does not receive any feedback whatsoever about the torque required for frictional fixation. In particular, when tightening the additional handgrip, an operator does not receive any feedback about the torque that is actually sufficient and satisfies the safety regulations. The consequence of this situation is that when the additional handgrip must be attached under time pressure in some cases, frictional fixation of the same on the hand-held power tool occurs in an unsatisfactory way. For example, a screw connection may be tightened too little, which may result in the hand-held power tool slipping in the additional handgrip. A screw connection may also be tightened too much, which may result in damage to the connection area of the hand-held power tool by the additional handgrip.

It is desirable to design the manipulation of the additional handgrip to be comparatively simple for the operator and, on the other hand, to facilitate feedback to the operator that makes it evident that the additional handgrip is attached correctly in terms of the safety regulations.

The invention comes into play at this point and its object is to disclose an additional handgrip, a hand-held power tool and a system whereby an attachment of the additional handgrip to a hand-held power tool that is improved with respect to the prior art is made possible. In particular, the attachment of the additional handgrip is meant to be designed to be comparatively simple. In particular, an additional handgrip is meant to be able to be attached comparatively securely to the hand-held power tool. In particular, the attachment of the additional handgrip to a hand-held power tool is specified such that it satisfies the safety regulations, and in particular this fact should be perceptible to the operator.

The invention starts from the consideration that although a screw connection basically permits a secure fastening of an additional handgrip on a hand-held power tool, the possibilities of a screw connection are limited, however, with respect to handling. The invention has recognized that it is possible as a departure from the concept of a screw connection to realize a locking coupling connecting the grip and the fastening element, which does justice to the different requirements for handling the additional handgrip. The invention has recognized that a first and second coupling part of the locking coupling should be designed in such that in any case there is the possibility of engaging or disengaging the locking coupling in a way that is (a) efficient in terms of time, (b) secure and (c) recognizable for the operator. The invention has recognized that this may be realized best by a first and a second coupling part, which are arranged along the locking coupling axis so they axially mesh. It is provided according to the invention that the first and second coupling parts form a bayonet lock for realizing the locking coupling with one another. According to the invention, the bayonet lock between the first and second coupling part has an engagement element engaging movably in a guide. In particular, the guide may be arranged on the first coupling part, wherein the engagement element is then arranged on the second coupling part. The guide may alternatively be arranged on the second coupling element, wherein the engagement element is then arranged on the first coupling part. An engagement element may be configured, for example, in the form of a pin, a rib, a peg, a knob or like elevation. The guide may be configured in particular in the form of a guide slot, a guide groove or a guide flank or the like. Any type of closeable sliding block guide, in which an aforementioned elevation engages in the guide or is adjacent to a guide flank in order to allow a restraint-guided movement of the elevation and of the guide relative to one another, shall be understood as a bayonet lock in this respect. The invention has recognized that the restraint-guided movement specified by a progression of the sliding block guide may be utilized in order to establish the movement of the engagement element between a first point of the guide and a second point of the guide in an advantageous manner to achieve the advantages of a locking coupling that are cited above as (a), (b), and (c). According to the invention, it is provided that in the case of a movement of the engagement element between a first point of the guide and a second point of the guide, the fastening element is adjusted between the attachment position and the detachment position.

The invention has thus recognized that a bayonet lock is advantageously suited to effectively, securely and recognizably devise for the operator a detachment or attachment of the fastening element at the connection area of the hand-held power tool while rotating the grip around the locking coupling axis. An operator may completely close or completely open a bayonet lock by rotating the grip, for example, only within a fraction of a full revolution, e.g., a half revolution. Correspondingly, the fastening element may be completely fastened or disengaged at the connection area of the hand-held power tool with less than a full revolution of the grip. In particular, because of the restraint-guided movement of the first and second coupling parts relative to each other, the operator receives recognizable feedback about the resistance of the restraint-guided movement, in particular about whether the bayonet lock is completely opened or completely closed.

Advantageous further developments of the invention can be found in the description and indicate in detail advantageous possibilities of realizing the idea explained above as related to the stated problem as well as with respect to additional advantages.

Within the framework of an especially preferred further development, the grip is a handgrip running axially largely along a single grip axis. The idea of the invention proved to be especially advantageous within the framework of the further development with the conformity of the grip axis and the locking coupling axis. The rotation of the grip may therefore be transferred advantageously to the locking coupling.

Within the framework of an especially preferred structural further development, the first coupling part is fastened directly on the grip, and/or the second coupling part is fastened directly on the fastening element. This permits an advantageous direct transmission of force from one coupling part to a grip or fastening element. A transmission of force between the coupling part and grip or fastening element has proven to be especially advantageous if the first coupling part is formed as one piece with the grip and/or the second coupling part is formed as one piece with the fastening element. In a modified embodiment, connecting force-transmitting parts may also be provided in a fixed or movable manner between the coupling part and grip or fastening element.

In a first further developed variation, the first coupling part may be configured in the form of a shaft and the second coupling part in the form of sleeve, wherein the shaft may engage axially in the sleeve. In a second further developed variation, the reverse may be provided in that the second coupling part is configured in the form of a shaft and the first coupling part in the form of a sleeve, wherein the shaft again engages axially in the sleeve. In the case of the two foregoing variations, an advantageous perfectly-fitting axial guide of the first and second coupling parts may be realized in particular. This is advantageously beneficial for the axial stability of the additional handgrip and supports the restraint-guided movement of the first and second coupling parts in the bayonet lock. In particular, a canting of the first and second coupling parts is advantageously prevented.

Within the framework of an especially preferred further development, it is provided that the point of the guide provided according to the idea of the invention is an end point of the guide. In other words, it is provided according to the further development that when moving the engagement element between a first end of the guide and a second end of the guide, the fastening element is adjusted between the attachment position and the detachment position. In the case of this further development, the attachment position of the fastening element and the detachment position of the fastening element are advantageously allocated exactly to a first or second end of the guide in the bayonet lock. Thus, the operator is able, within the course of a single rotational movement, i.e., without gripping around, to move the engagement element completely between the end points of the guide and strike there respectively. The limit stop is recognizable to the operator due to a limit stop resistance so that the operator receives feedback when the bayonet lock is securely closed or securely disengaged. The operator knows at a first limit stop, for example, that the fastening element is adequately disengaged in order to be able to also actually remove the additional handgrip from the hand-held power tool. The operator also knows at a second limit stop that the fastening element is adequately attached or fixed at the connection area of the hand-held power tool in order to permit a secure operation of the hand-held power tool.

Within the framework of an especially advantageous further development, it is also provided that the guide has a progression with a first area having a first slope and a second area having a second slope. The first slope is advantageously steeper than the second slope. The last-mentioned design of the progression already provides, through the restraint-guidance of the engagement element in the first area, the possibility of a comparatively large tension path for the fastening element to cover. With the same exertion of force, the design of the second area allows the fastening element to apply comparatively high forces for fixing the same at the connection area of the hand-held power tool.

Within the framework of an especially preferred additional further development, the guide has an additional third area having a third slope. An extremal turning point of the progression is advantageously provided between the second and third areas. In other words, the third slope has a different algebraic sign than the first or second slope. During tensioning attachment of the fastening element, the third area is advantageously used for guidance of the engagement element on the other side of the extremal turning point in order to fix the same in an end area of the guide. An unintended detachment of a fastening element from the connection area of the hand-held power tool is thereby prevented in an especially secure manner.

An especially smooth actuation of the bayonet lock is made possible in that the guide in the framework of a further development has an essentially concavely arched progression. A concavely arched progression should be understood in particular as a progression with a positive curvature.

The lengths of the aforementioned first, second and third areas can also be coordinated with the path lengths for fixation of a fastening element at the connection area. The third area is preferably shorter than the first area and shorter than the second area. An especially preferred further development provides that the second area is shorter than or equal to the length of the first area.

Even if the idea of the invention particularly with respect to a handgrip that is aligned largely axially along a single grip axis is advantageous, this allows in particular a design of the handgrip that is not exactly in a straight line or bent in sections, for example. In addition, the idea of the invention may be applied to a handgrip which is configured, for example, in the form of a completely closed bracket or a bracket that is bent to a large extent in a full angle but is open.

The idea of the invention has proven to be advantageous for a hand-held power tool in the form of a combination device such as, for example, a hammer drill, a boring tool or the like, such as, for example, a chipping hammer. However, it may also be used on hand-held power tools which are designed only as chisels or drills or the like. It has been shown that particularly in the case of combination devices, an additional handgrip has two functions to fulfill, which are advantageously supported by the idea of the invention. Above all, guidance of the hand-held power tool is meant to be facilitated during chiseling. During drilling, the additional handgrip serves above all to contain the torque if a tool jams.

In this connection, it has been shown to be advantageous that the connection area is a tool neck, wherein the additional handgrip is formed as a side handgrip, which is aligned transverse to a main handgrip of the hand-held power tool.

The idea of the invention also leads to a system of a hand-held power tool and an additional handgrip such as arranged, for example, in a hand tool box or the like.

Exemplary embodiments of the invention are described in the following on the basis of the drawings. These drawings are not necessarily supposed to represent the exemplary embodiments to scale; rather, the drawings are executed in a schematic and/or slightly distorted form when it is useful for explanatory purposes. Reference is made to the pertinent prior art with respect to additions to the teachings directly identifiable from the drawings. It must be taken into consideration in this case that a wide range of modifications and changes related to the form and detail of an embodiment can be undertaken without deviating from the general idea of the invention. The features of the invention disclosed in the description, in the drawings as well as in the claims may be essential for the further development of the invention both separately as well as in any combination. Moreover, all combinations of at least two features disclosed in the description, the drawings and/or the claims fall within the scope of the invention. The general idea of the invention is not restricted to the exact form or detail of the preferred embodiment described and depicted in the following or restricted to a subject matter which would be limited as compared to the subject matter claimed in the claims. In the case of any dimensioning ranges given, values within the stated limits are also meant to be disclosed as limit values, and be applicable at will and claimable. For the sake of simplicity, the same reference numbers are used in the following for identical or similar parts having an identical or similar function.

Additional advantages, features and details of the invention are disclosed in the following description of the preferred exemplary embodiments as well as on the basis of the drawings.

### BRIEF DESCRIPTION OF THE DRAWINGS

FIG. 1 is a schematic representation of an electrically operated hand-held power tool, in the present case in the form of a power hammer drill having an additional handgrip according to an embodiment that is aligned to a large extent axially and laterally to a main handgrip;

FIG. 2 illustrates an additional handgrip, as it is shown exemplarily in FIG. 1, in a sectional representation transverse to axis A of FIG. 1;

FIG. 3 is a detailed view of the locking coupling with a bayonet lock of FIG. 2 in a first and a second end position (A), (B), which corresponds to a detached position of the fastening element or a closed position of the fastening element at a connection area of the hand-held power tool; and

FIG. 4 illustrates an embodiment of a progression of a guide of the bayonet lock with three areas having different slopes.

### DETAILED DESCRIPTION OF THE DRAWINGS

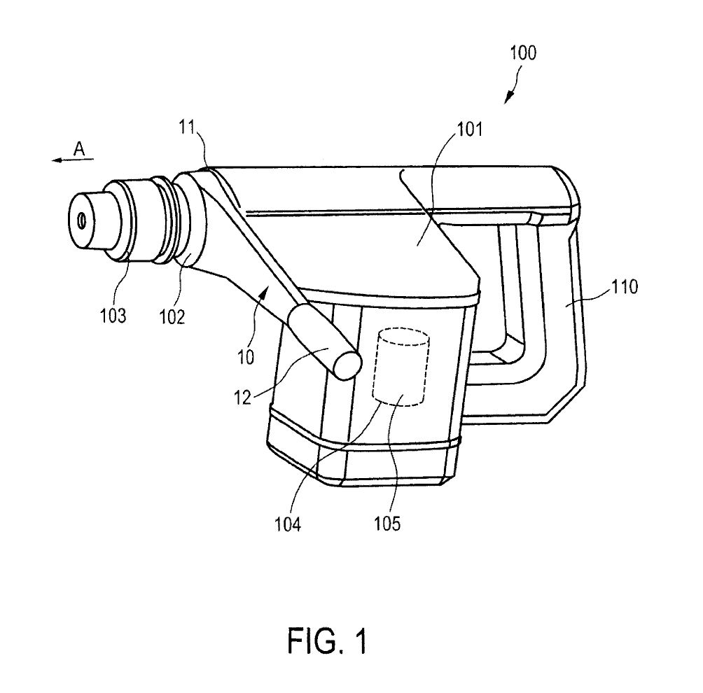

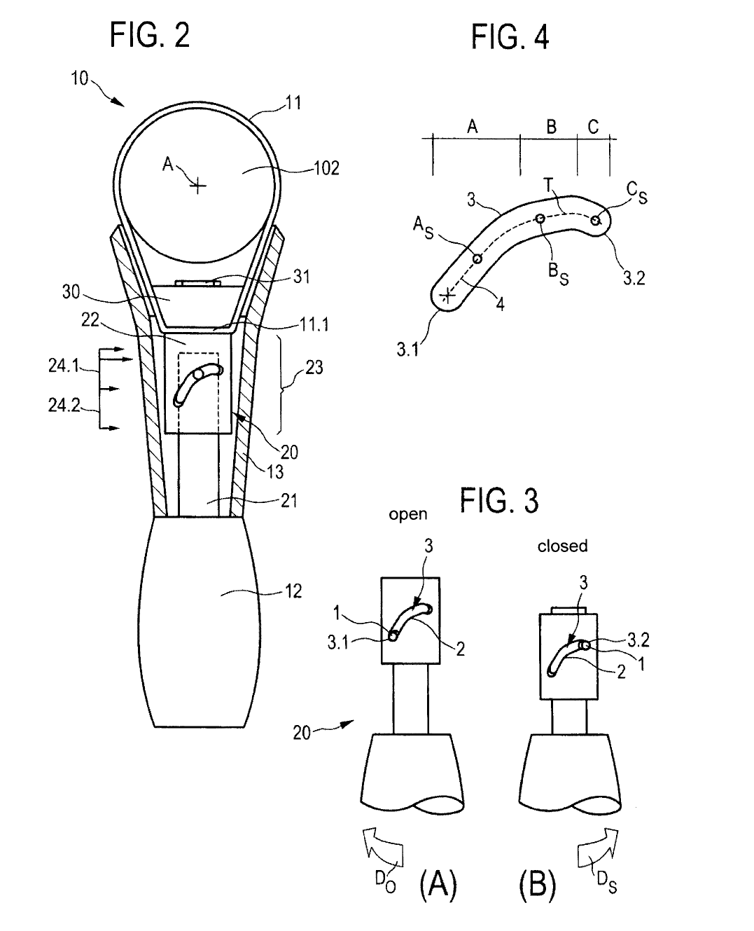

FIG. 1 shows a hand-held power tool 100, in the present case in the form of a power hammer drill, having a housing 101 and having a guide part for positioning a drive shaft (not described in more detail) for a tool receptacle 103. The guide part in the present case forms the connection area 102 in the form of a tool neck. At the connection area 102, an additional handgrip 10 can be attached to the hand-held power tool 100, in addition to a main handgrip 110 formed by the housing 101. In the present case, the additional handgrip 10 is aligned as a side handgrip transverse to the main handgrip 110 and is fastened via a fastening element 11 (shown in more detail in FIG. 2) in the form of a tension band on the connection area 102. The housing 101 of the hand-held power tool 100 also includes a motor housing 104 with a symbolically depicted electric motor 105 for driving the drive shaft.

The additional handgrip 10 is depicted in detail in FIG. 2. The additional handgrip 10 has a grip 12 adapted to the haptics of the operator's hand on the proximal end of the additional handgrip 10, and, on the opposite distal end, the connection area 102 is configured in the form of the fastening element 11 including the tool neck in the form of the tension band in which the axis A of the drive shaft of the hand-held power tool 100 runs approximately in the center. The grip 12 and the fastening element 11 are connected to each other via a locking coupling 20. The locking coupling 20 is accommodated in a protective housing 13 of the additional handgrip 10, which is located in the distal direction above the grip 12 and surrounds the locking coupling 20 in a manner that is adapted to its shape. Towards the distal end, the protective housing 13 surrounds the fastening element 11 in the projection while leaving a space free to accommodate the connection area 102 in the tension band. In the projection of the fastening element 11, the protective housing 13 also surrounds a clamping piece 30, which is defined with a base 31 on the distal side of a fastening section 11.1 of the fastening element 11, i.e., within the tension band.

When the locking coupling 20 is closed, the clamping piece 30 is frictionally pressed against the connection area 102 in the tension band in such a way that the additional handgrip 10 is securely fixed on the tool neck of the hand-held power tool 100, e.g., in the position depicted in FIG. 1. The base 31 on the side of the connection area 102 makes an especially good frictional connection possible.

In detail, the locking coupling 20 has a first coupling part 21 in the form of a tension shaft, which, in this embodiment, is directly connected as one piece with the grip 12. When rotating the grip 12, the tension shaft is directly rotated along with it. In addition, the locking coupling 20 has a second coupling part 22 fastened directly on the proximal side of the fastening section 11.1. The second coupling part 22 is fastened on the proximal side of the fastening section 11.1 opposite from the clamping piece 30.

The second coupling part 22 configured as a guide sleeve accommodates, in the axial direction, a distal end of the first coupling part 21 in the form of the tension shaft that engages with a perfect fit. As a result, an axially displacing guidance of the tension shaft in the guide sleeve that allows axial and mutual rotation and prevents canting in particular is guaranteed.

The tension shaft and the guide sleeve overlap in an engagement area 23 to form a bayonet lock 3 shown in more detail in FIG. 3. In the present case, the bayonet lock 3 is formed by an engagement element 1 engaging in a moveable manner in a guide 2. In the present case, the engagement element 1 is configured in the form of a peg. The guide 2 is configured in the form of a guide groove. The peg is arranged on a distal end area of the tension shaft. The guide groove is arranged in a proximal end area of the guide sleeve. The end areas overlap in the process in a suitable way with the engagement area 23 and are designated by 24.1 or 24.2 for the sake of simplicity. The peg has a height, which is adequate to be forcibly guided against resistance in the guide groove. As FIG. 3 shows, this thus guarantees that with rotation Do in the opening direction of the grip 12, the engagement element 1 is moved up to an end point 3.1 of the guide 3 and strikes there. As FIG. 3B shows, with rotation D_{S} in the closing direction, the engagement element 1 is moved in the guide 2 up to an end point 3.2 and strikes there. The end point 3.1 corresponds in this embodiment to a sufficiently detached position of the fastening element 11, which allows the additional handgrip 10 to be removed from the connection 102. In contrast, when the engagement element 1 strikes the end point 3.2, it is guaranteed that the fastening element 11 is sufficiently fixed at the connection area 102 in order to allow a secure operation of the hand-held power tool even with high loads. In particular, guidance of the power hammer drill is facilitated as well as a containment of torque during drilling and if applicable blocking a tool in the tool receptacle 102. In particular, the open position of the bayonet lock 3 shown in FIG. 3A conforms exactly to a detached position of the tension band and the closed position of the bayonet lock 3 shown in FIG. 3B conforms exactly to a tensioned fixed position of the tension band on the tool neck. In the case of approximately half a revolution of the grip 12, it is therefore noticeably apparent to the operator when the end points 3.1 and 3.2 are struck such that the additional handgrip 10 may be securely detached or is fixed. The rotational movements D_{O}, D_{S} are possible virtually without gripping around.

In addition, as shown in detail in FIG. 4, the progression 4 of the guide 2 is adapted in this embodiment precisely to the requirements of the tensioning attaching or detaching movement of the fastening element 11. Basically, it was recognized that a revolution path, e.g., during a tensioning attachment of the fastening element 11 on the tool neck, is accompanied by different resistances due to the tensioning force to be applied. In the case of slight resistance, a rotational path of the grip 12 may be assigned a comparatively large stroke of the progression 4 of the guide 3. With increasing resistance, a same rotational path of the grip 12 may be assigned a smaller stroke of the progression 4. The stroke in this case corresponds to a tension path of the fastening element 11. Correspondingly, the progression of the guide 3 in FIG. 4 provides for three areas A, B and C, in which the progression 4 has different slopes designated by A_{S}, B_{S} and C_{S}. The slope A_{S} in the first area A is selected to be comparatively steep and exceeds in terms of its extent a comparatively flat slope B_{S} in the second area B. In the third area, the progression 4 has a slope C_{S}, which has a different algebraic sign than the slopes A_{S}, B_{S}, (negative in this case). All in all, the progression 4 of the guide 3 is thus designed in a manner that is essentially concavely arched with an overall positive curvature. When the grip 12 is rotated, the engagement element 1 essentially follows, in the course of its restraint-guided movement, the progression 4 having first a steep slope A_{S} and then a flat slope B_{S}, and when it surmounts an upper extremal turning point, also called dead point T, the engagement element 1 virtually engages in the third area C on the other side of the dead point T and strikes the end 3.2 of the guide 3.

Such a geometric design of the progression 4 guarantees that in the first area A with comparatively low resistance between the fastening element 11 and the connection area 102, a comparatively great tension path may be covered, while in the second area B_{S} a sufficient tensioning force can be applied for final tightening of the fastening element 11 at the connection area 102. In the case of an only negligible reduction of the final tensioning force of the fastening element 11 at the connection area 102, the engagement element 1 is finally securely engaged in the third area C against an unintentional detachment of the locking coupling 20 on the other side of dead point T.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A handgrip, comprising:
a fastening element, wherein the fastening element is attachable to a connection area of a hand-held power tool;
a grip; and
a locking coupling connecting the fastening element to the grip;
wherein the locking coupling is adjustable with a rotation of the grip around a locking coupling axis between an attachment position of the fastening element and a detachment position of the fastening element;
wherein the locking coupling includes a first coupling part that is actuatable via the grip and a second coupling part, wherein the fastening element is adjustable by the second coupling part;
and wherein the first and second coupling parts form a bayonet lock, wherein when the bayonet lock is in a first position the fastening element is in the attachment position and when the bayonet lock is in a second position the fastening element is in the detachment position.

2. The handgrip according to claim 1, wherein the first coupling part is fastened directly on the grip and the second coupling part is fastened directly on the fastening element.

3. The handgrip according to claim 1, wherein the first coupling part is a shaft and the second coupling part is a sleeve and wherein the shaft engages axially in the sleeve.

4. The handgrip according to claim 1, wherein the second coupling part is a shaft and the first coupling part is a sleeve and wherein the shaft engages axially in the sleeve.

5. The handgrip according to claim 1, wherein the bayonet lock includes an engagement element and a guide, wherein the engagement element is disposed within the guide.

6. The handgrip according to claim 5, wherein the guide has a first area with a first slope and a second area with a second slope.

7. The handgrip according to claim 6, wherein the guide has a third area with a third slope and a turning point between the second area and the third area.

8. The handgrip according to claim 7, wherein the second slope is flatter than the first slope and the third slope has a negative slope.

9. The handgrip according to claim 5, wherein the guide has an overall positive curvature.

10. The handgrip according to claim 7, wherein the third area is shorter than the first area and is shorter than the second area and wherein the second area is shorter than the first area.

11. The handgrip according to claim 1, wherein the fastening element includes a fastening section and a clamping piece, wherein the clamping piece is disposed on a first side of the fastening section and the second coupling part is disposed on a second side of the fastening section.

12. The handgrip according to claim 1, wherein the grip has a grip axis and wherein the grip axis conforms to the locking coupling axis.

13. The handgrip according to claim 5, wherein the engagement element is disposed on the first coupling part and the guide is disposed on the second coupling part.

14. The handgrip according to claim 5, wherein the engagement element is disposed on the second coupling part and the guide is disposed on the first coupling part.

15. A hand-held power tool, comprising:
a first handgrip, including:
a fastening element;
a grip; and
a locking coupling connecting the fastening element to the grip;
wherein the locking coupling is adjustable with a rotation of the grip around a locking coupling axis between an attachment position of the fastening element and a detachment position of the fastening element;
wherein the locking coupling includes a first coupling part that is actuatable via the grip and a second coupling part, wherein the fastening element is adjustable by the second coupling part;
and wherein the first and second coupling parts form a bayonet lock, wherein when the bayonet lock is in a first position the fastening element is in the attachment position and when the bayonet lock is in a second position the fastening element is in the detachment position; and
a second handgrip including a connection area;
wherein the fastening element of the first handgrip is attached to the connection area of the second handgrip.

16. The hand-held power tool according to claim 15, wherein the first handgrip is aligned transverse to the second handgrip.

17. A handgrip, comprising:
a fastening element;
a grip; and
a locking coupling connecting the fastening element to the grip;
wherein the locking coupling includes a bayonet lock.
